(19) United States
(12) Patent Application Publication
(10) Pub. No.: US 2018/0099532 A1
(43) Pub. Date: Apr. 12, 2018

(54) PNEUMATIC TIRE

(71) Applicant: TOYO TIRE & RUBBER CO., LTD., Itami-shi (JP)

(72) Inventor: Kei Miyamura, Itami-shi (JP)

(73) Assignee: TOYO TIRE & RUBBER CO., LTD., Itami-shi (JP)

(21) Appl. No.: 15/693,570

(22) Filed: Sep. 1, 2017

(30) Foreign Application Priority Data
Oct. 11, 2016 (JP) 2016-199681

(51) Int. Cl. B60C 19/08; B60C 11/00

(52) U.S. Cl. CPC B60C 19/082; B60C 11/005

(57) ABSTRACT

A pneumatic tire has a tread rubber. The tread rubber has a cap rubber, a base rubber, and a conductive portion. The cap rubber which is formed by a non-conductive rubber and constructs a ground contact surface. The base rubber which is provided in an inner side of the cap rubber in the tire radial direction. The conductive portion which is formed by a conductive rubber, extends in a thickness direction of the tread rubber and reaches a bottom surface of the tread rubber from the ground contact surface. The conductive portion extends in a tire circumferential direction while oscillating its width in a tire width direction in a plan view.

### BACKGROUND OF THE INVENTION

### Field of the Invention

The present disclosure relates to a pneumatic tire which can discharge static electricity generated in a vehicle body and the tire to a road surface.

### Description of the Related Art

In recent years, for the purpose of reducing a rolling resistance of a tire which has strong relationship to a fuel consumption performance, there has been proposed a pneumatic tire in which a rubber member such as a tread rubber is formed by a non-conductive rubber blended with silica at a high rate. However, since art electric resistance is higher in the rubber member in comparison with a conventional product which is formed by a conductive rubber blended with carbon black at a high rate, and inhibits static electricity generated in a vehicle body or the tire from being discharged to a road surface, the rubber member has a problem that a problem such as a radio noise tends to be generated. Consequently, it is necessary to appropriately secure a conductive route for discharging the static electricity.

JP-A-118711 discloses a tire in which a conductive rubber sheet having a fixed width is arranged from a ground contact surface to a bottom surface of a tread rubber. There is a description that since the conductive rubber sheet extends like a wavy form continuously in a thickness direction and a circumferential direction of the tread rubber, an input in a tire lateral direction is effectively dispersed and a durability is improved.

### SUMMARY OF THE INVENTION

The present disclosure is made by taking the above circumstances into consideration, and an object of the present disclosure is to provide a pneumatic tire having a conductive portion which achieves other functions than the conductive path.

The present disclosure employs the following means for achieving the object.

In other words, according to the present disclosure, there is provided a pneumatic tire including a pair of bead portions, a side wall portion which extends to an outer side in a tire radial direction from each of the bead portions, a tread portion which is connected to an outside end in the tire radial direction of each of the side wail portions, a toroidal carcass layer which is provided between the pair of bead portions, and a tread rubber which is provided in an outer side of the carcass layer in the tread portion. The tread rubber has a cap rubber which is formed by a non-conductive rubber and constructs a ground contact surface, a base rubber which is provided in an inner side of the cap rubber in the tire radial direction, and a conductive portion which is formed by a conductive rubber, extends in a thickness direction of the tread rubber and reaches a bottom surface of the tread rubber from the ground contact, surface. The conductive portion extends in a tire circumferential direction while oscillating its width in a tire width direction in a plan view.

As mentioned above, since the width of the conductive portion in the tire width direction oscillates in the plan view, the force heading for the front side acts on the cap rubber in one side in the tire width direction at a time of braking. As a result, the conductive portion can sufficiently support the cap rubber and can absorb the force even in the case that the force heading for the rear side (the so-called vertically displacing force) acts on the cap rubber in the other side in the tire width direction. Therefore, the durability performance is improved. Further, the durability performance is improved in relation to the lateral force at a time of cornering.

### BRIEF DESCRIPTION OF THE DRAWINGS

FIG. 1 is a tire meridian cross sectional view showing an example of a pneumatic tire according to the present disclosure;

FIG. 2 is a perspective view showing a conductive portion;

FIG. 3 is a plan view showing a conductive portion in a wheel tread, a center portion of a tread thickness and a tread bottom surface;

FIG. 4A is a plan view showing a modified example of a shape of the conductive portion;

FIG. 4B is a plan view showing a modified example of the shape of the conductive portion;

FIG. 4C is a plan view showing a modified example of the shape of the conductive portion;

FIG. 5A is a plan view showing a positional relationship between a groove and a conductive portion, according to the other embodiment than the above;

FIG. 5B is a plan view showing a positional relationship between a groove and a conductive portion according to the other embodiment than the above; and

FIG. 6 is a perspective view showing a conductive portion according to the other embodiment than the above.

### DETAILED DESCRIPTION OF THE PREFERRED EMBODIMENTS

A description will be given below of a pneumatic tire according to an embodiment of the present disclosure with reference to the accompanying drawings.

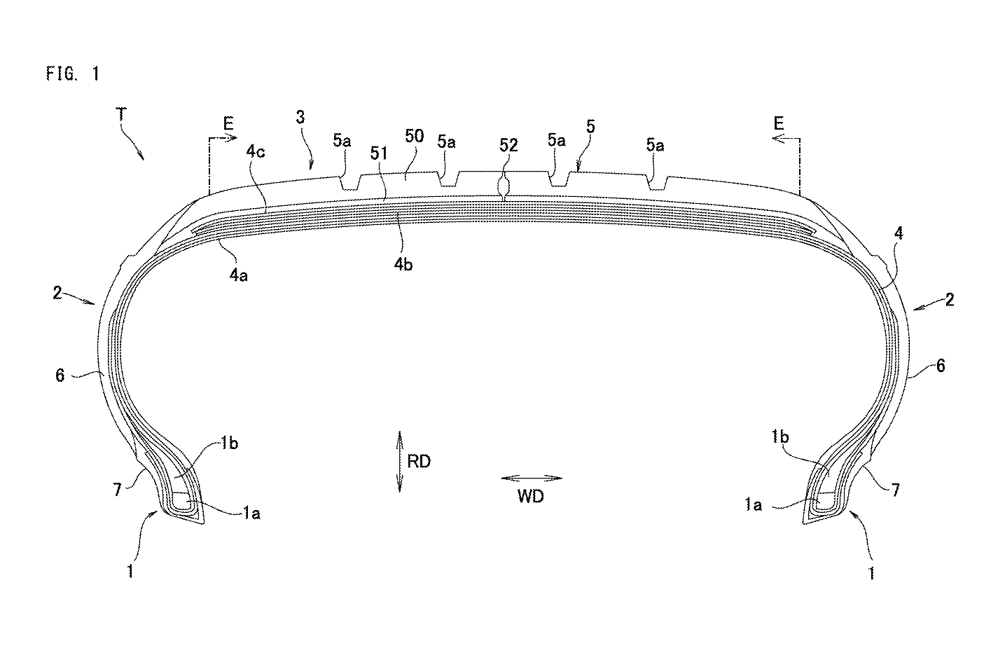

As shown in FIG. 1, a pneumatic tire T is provided with a pair of bead portions 1, side wall portions 2 which extend to outer sides in a tire radial direction RD from the respective bead portions I, and a tread portion 8 which is connected to outside ends in the tire radial direction RD from both the side wall portions 2. An annular bead core 1a and a bead filler 1b are arranged in the bead portion 1, the annular bead core 1a covering a convergence body such as a steel wire by a rubber, and the bead filler 1b being made of a hard rubber,

Further, the tire T is provided with a toroidal carcass layer 4 which runs into the bead port ions 1 from the tread portion 3 via the side wall portions 2. The carcass layer 4 is provided between a pair of bead portions 1, is constructed by at least one carcass ply, and is locked in a state in which its end portions are rolled, up via the bead cores 1a. The carcass ply is formed by coating with a topping rubber a cord which extends approximately vertically to a tire equator CL. An inner liner rubber 4a for retaining a pneumatic pressure is arranged in an inner side of the carcass layer 4.

Further, a side wall rubber 6 is provided in an outer side of the carcass layer 4 in the side wall portion 2. Further, a rim strip rubber 7 is provided in an outer side of the carcass layer 4 in the bead portion 1, the rim strip rubber 7 coming into contact with a rim (not shown) when being installed to the rim. In the present embodiment, the topping rubber of the carcass layer 4 and the rim strip rubber 7 are formed of a conductive rubber, and the side wall rubber 6 is formed of a nonconductive rubber.

An outer side of the carcass layer 4 in the tread portion 3 is provided with a belt 4b for reinforcing the carcass layer a bet reinforcing member 4c, and a tread rubber 5 in this order from an inner side toward an outer side. The belt 4b is constructed by a plurality of belt plies. The belt reinforcing member 4b is constructed by coating a cord extending in a tire peripheral direction with a topping rubber. The belt reinforcing member 4b may be omitted as occasion demands.

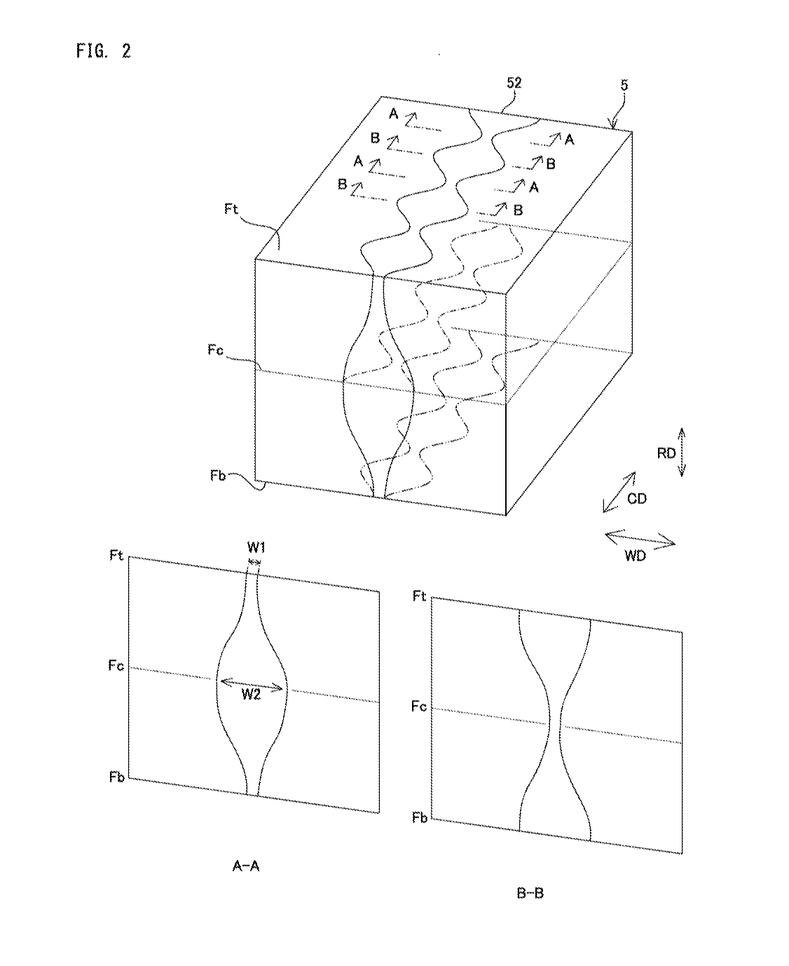

As shown in FIGS. 1 and 2, the tread rubber 5 has a cap rubber 50 which is formed of the nonconductive rubber and constructs a ground surface E, a base rubber 51 which is provided in an inner side in a tire radial direction of the cap rubber 50, and a conductive portion 52 which is formed of the conductive rubber and reaches a side surface 50a of the cap rubber 50 from the ground surface E. A plurality of main grooves 5a extending along a tire circumferential direction are formed on a surface of the cap rubber 50. The main grooves 5a are provided with a Tread Wear Indicator (TWI) which is a projection protruding out of a groove bottom. The TWI indicates a tire replacement time due to wear of the tire. In the present embodiment, the base rubber 51 is formed of the conductive rubber, however, may be formed of the nonconductive rubber.

In the above, the ground surface is a surface which is grounded onto a road surface when the tire is vertically put on a flat road surface in a state in which the tire is assembled in a normal rim, and a nomal internal pressure is filled, and a normal load is applied to the tire, and an outermost position in the tire width direction WD comes to a ground end E. The normal load and the normal internal pressure indicate a maximum load, (a design normal load in the case of a tire for a passenger car) which is defined in JISD4202 (specification of an automotive tire) and a corresponding pneumatic pressure, and the normal rim indicates a standard rim which is defined in JISD4202 in principle.

The present embodiment employs a side-on tread structure achieved by mounting the side wall rubbers 6 onto both side end portions of the tread rubber 5, however, can employ a tread-on side structure achieved, by mounting both side end portions of the tread rubber onto outer ends in the tire radial direction RD of the side wall rubbers, without being limited to the side-on tread structure.

Here, the conductive rubber is exemplified by a rubber in which a volume resistivity indicates a value less than 10⁸ Ω·cm, and is produced, for example, by blending a carbon black serving as a reinforcing agent in a raw material rubber at a high rate. The conductive rubber can be obtained by blending a known conductivity applying agent, for example, a carbon-based conductivity applying agent such as a carbon fiber or a graphite, and a metal-based conductivity applying agent, such as a metal powder, a metal oxide, a metal flake or a metal fiber, in addition to the carbon black.

Further, the non-conductive rubber is exemplified by a rubber in which a volume resistivity indicates a value equal to or more than 10⁸ Ω·cm, and is exemplified by a material obtained by blending a silica serving as a reinforcing agent in the raw material rubber at a high rate. The silica is blended, for example, at 30 to 100 weight part in relation to 100 weight part of the raw material rubber component. The silica preferably employs a wet silica, however, can use any silica which is generally used as the reinforcing agent, without limitation. The non-conductive rubber may be produced by blending a burned clay, a hard clay, or a calcium carbonate, in addition to the silica such as a precipitated silica or a silicic anhydride.

As the raw material rubber mentioned above, a natural rubber, a styrsne butadiene rubber (SBR), a butadiene rubber (BR), an isoprene rubber (IR) and an isobutylene-isoprene rubber (IIR) can be listed up, and they are used respectively by itself or by mixing two or more kinds. A vulcanizing agent, a vulcanization accelerator, a plasticizer or an antioxidant is appropriately blended in the raw material rubber.

In the light of enhancing a durability and improving a conduction performance, the conductive rubber desirably has a composition that a nitrogen adsorption specific surface area: N₂SA (m²/g) X composition amount (mass %) of carbon black is equal to or more than 1900, preferably equal to or more than 2000, and a dibutyl phthalate oil absorption: DBF (ml/100 g) X composition amount (mass %) of carbon black is equal to or more than 1500, preferably equal to or more than 1700. N₂SA can be determined in conformity to ASTM D3037-89, and DBP can be determined in conformity to D2414-90.

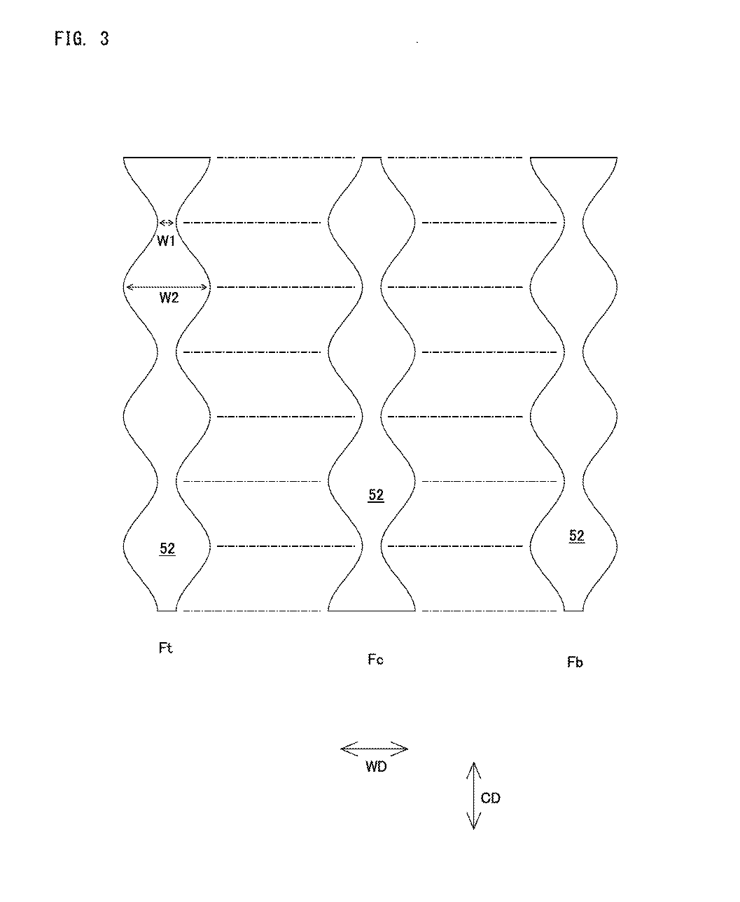

FIG. 2 is a perspective view showing the conductive portion 52. FIG. 3 shows a plan view of the conductive portion 52 in a wheel tread Ft, a plan view of the conductive portion 52 in a center portion Fc of a tread thickness and a plan view of the conductive portion 52 in a tread bottom surface Fb. As shown in FIGS. 1 to 3, the conductive portion 52 is formed by a conductive rubber, and reaches a bottom surface of the tread rubber 5 from the ground contact surface E. In the present, embodiment, the conductive portion 52 passes through the cap rubber 50 and the base rubber 51, comes into contact, with the belt reinforcement member 4c and constructs a conductive route. The conductive portion 52 extends in a tire circumferential direction CD while osciiiating its width in a tire width direction WD in a plan view.

Since the width of the conductive portion 52 in the tire width direction WD is oscillated in the plan view as mentioned above, the conductive portion 52 can sufficiently support the cap rubber 50 and can absorb the force even if the force heading for a front side acts on the cap rubber in one side in the tire width direction and the force heading for a rear side (so-called force in a vertically displacing direction) acts on the cap rubber 50 in the other side in the tire width direction at. a time of braking. As a result, a durability performance is improved. Further, a durability performance to a lateral force at a time of cornering is improved. On the other hand, in the case that the width of the conductive rubber is fixed as in JP-A-11-48711, the structure cannot support the force in the vertically displacing direction and cannot support the lateral force.

Further, the conductive portion 52 extends in the thickness direction RD while oscillating its width in the tire width direction WD in the tire meridian cross section. As shown in a cross sectional view along a line A-A and a cross sectional view along a line B-B in FIG. 2, the shape of the conductive portion 52 is different, according to the cross section. As shown in the cross sectional view along the line A-A, the width in the center portion Fc in the thickness direction is enlarged in the case that the width of the conductive portion 52 exposed to the wheel tread Ft is small. On the contrary, in the case that the width of the conductive portion 52 exposed to the wheel tread Ft is large, the width in the center portion Fc in the thickness direction is reduced, as shown in the cross sectional view along the line B-B. As shown in FIG. 3, in the present embodiment, a plan shape of the conductive portion 52 in the tread thickness center portion Fc is deviated in a phase of oscillation in relation to a plan shape of the conductive portion 52 in the wheel tread Ft and the tread bottom surface Fb, in a plan view. In the wheel tread Ft and the tread bottom surface Fb, the phase of oscillation of the plan shapes of the conductive portion 52 coincide with each other or approximately coincide with each other. Of course, the phases at three positions may be all different front each other.

As mentioned above, since the width of the conductive portion 52 in the tire width direction WD extends in the thickness direction RD while oscillating in the tire.meridian cross section, a surface area of the conductive portion 52 is increased. As a result, an interfacial peeling is suppressed and a durability performance is improved. In the case that the hardness of the conductive portion 52 is higher than that of the cap rubber 50, a steering stability on a dry road surface is improved on the basis of an even rigidity increase. On the contrary, in the case that the hardness of the conductive portion 52 is lower than that of the cap rubber 50, the steering stability and a braking performance on a wet road surface are improved on the basis of an even ground contact.

In the present embodiment, both end interfaces of the conductive portion 52 in the tire width direction WD are both formed into such a shape as to oscillate. In this case, the minimum width W1 of the conductive portion 52 is preferably equal to or more than 0.1 mm and equal to or less than 1.5 mm. A current-carrying performance can be easily secured since the minimum width W1 i s set to be equal to or more than 0.1 mm. Further, the volume of the conductive rubber can be suppressed and the effect of improving the braking performance can be better achieved since the minimum width W1 is equal to or less than 1.5 mm. The maximum width W2 is preferably equal to or more than 300% of the minimum width W1, and equal to or less than 500% of the minimum width W1. In the above example, a range between 0.5 mm and 7.5 mm can be listed up.

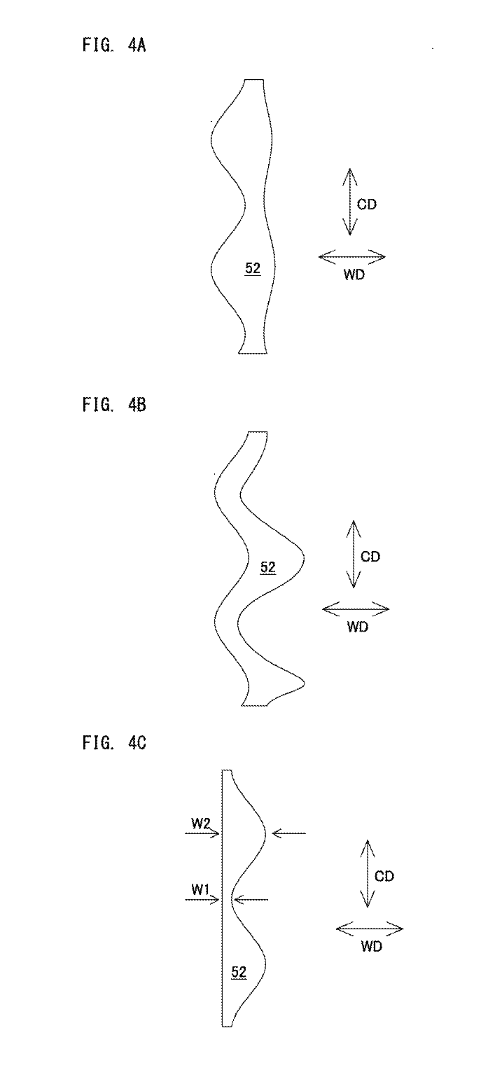

In the present embodiment, the oscillations of both ends of the conductive portion 52 coincide in.relation to a certain virtual center line, however, the structure is not limited to this. For example, as shown in FIG. 4A, the oscillations of both ends of the conductive portion 52 may be different in relation to a certain virtual center line. Further, as shown in FIG. 4B, the conductive portion 52 may be meandering by differentiating the oscillations and the phases of both ends of the conductive portion 52. Further, as shown in FIG. 4C, only one end of the conductive portion 52 may oscillate. The maximum width W2 in the case shown in FIG. 4C is preferably equal to or more than 150% of the minimum width M1 and equal to or less than 250% of the minimum width W1. In the above example, a range between 0.25 mm and 4.0 mm can be listed up.

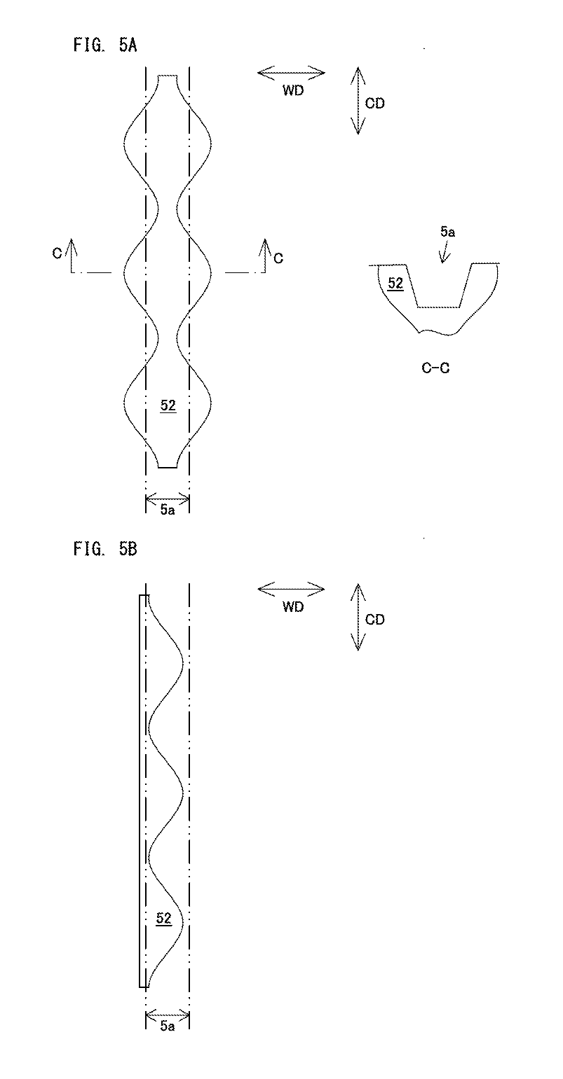

The conductive portion 52 does not lap over the groove 5a in the plan view as shown in FIGS. 1 to 3, however, the conductive portion 52 partly laps over the groove 5a extending in the tire circumferential direction CD in the plan view as shown in FIGS. 5A and 5B. Further, a part of the conductive portion 52 constructs the ground contact surface E, and the other portion thereof constructs the groove wall. In the example shown in FIG. 5A, there exists a position where the groove wall surface and the groove bottom surface constructing the groove 5a are formed by the conductive rubber 52 as a whole, as shown in a cross section along a line C-C.

A range between 60 and 80 can be listed up as the rubber hardness of the cap rubber 50. A range between 60 and 80 can be listed up as the rubber hardness of the conductive rubber 52. The rubber hardness here means a hardness which is measured according to a durometer hardness test (type A) of JISK6253.

### Other Embodiment

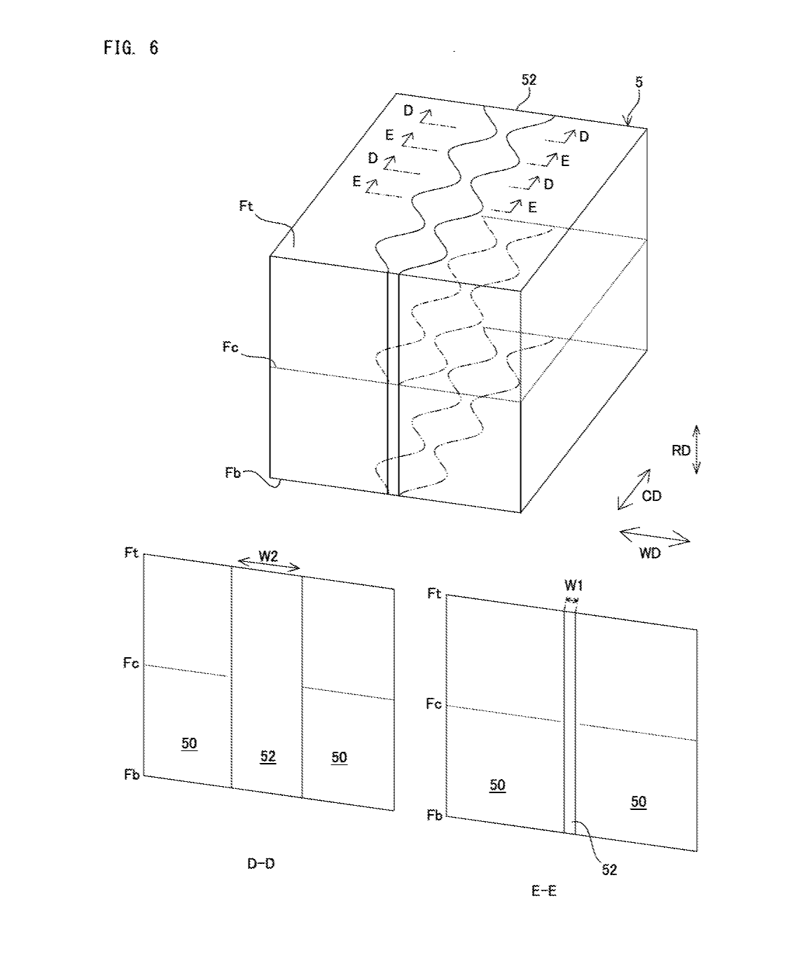

In the embodiment mentioned above, the width of the conductive rubber 52 oscillates in relation to both of the tire circumferential direction CD and the thickness direction RD, however, the structure is not limited to this. For example, as shown in FIG. 6, the width of the conductive portion 52 may oscillate in relation to the tire circumferential direction CD, and may be fixed in the thickness direction RD.

### EXAMPLES

In order to specifically indicate the structure and the effect of the present disclosure, the following evaluations were made with regard to the following example.

### (1) Durability Performance

The peeling force was measured in the conductive portion 52 and the cap rubber 50 (the non-conductive rubber). In the comparison of the peeling force between the conductive portion and the cap rubber (the non-conductive rubber), the comparison was made by setting a traveling distance until breaking occurs due to the peeling to an index number, in the tire durability test. Results of evaluation of the peeling force were shown by an index number obtained by setting a Comparative example 1 to 100. The greater numerical value means the higher adhesiveness and the higher durability.

### (2) Steering Stability (Dry and Wet)

Each of the tires was installed to a vehicle of a Japanese sedan (2000 cc), and an internal pressure was designated by the vehicle. A turning travel was executed on a dry road surface and a wet road surface in a state in which two passengers were in a car, and the evaluation was made according to a sensory test of a driver. A result was expressed by an index number in which the result of the tires in the Comparatives example 1 is 100. The greater numerical value means the more excellent stearing stability.

### (3) Braking Performance

Each of the tires was installed to the vehicle of the Japanese sedan (2000 cc) a braking distance was measured when an ABS was actuated from, a state of traveling on the road surface at a speed of 100 km/h, and an inverse number to the measured value was calculated . The evaluation was made by an index number in. which the result of the Comparative example 1 was 100, and the greater index number means the more excellent braking performance.

### Comparative Example 1

As shown in JP-A-11-48711, there was provided the conductive sheet which reached the bottom surface Fb of the cap rubber 50 from the ground contact surface E and had the fixed width. The conductive sheet is curved in the tire circumferential direction CD and the thickness direction RD, however, has fixed thickness. The rubber hardness of the cap rubber 50 was set to 70 degrees, and the rubber hardness of the conductive sheet, was set to 60 degrees,

As shown in FIG. 5B, there was provided the conductive portion 52 which was oscillated its width in the tire circumferential direction CD and the thickness direction RD. The rubber hardness of the cap rubber 50 was set to 70 degrees, and the rubber hardness of the conductive portion 52 was set to 60 degrees.

TABLE 1

| | Comparative example 1 | Example 1 |
|---|---|---|
| Thickness of | Width in tire width | Oscillate in circumferential |
| conductive | direction is fixed | direction and thickness |
| portion | Curved in circumferential | direction in width in tire |
| | direction | width direction |
| | Curved in thickness | Curved in circumferential |
| | direction | direction |
| | | Curved in thickness |
| | | direction |
| Durability | 100 | 110 |
| performance | | |
| Steering | 100 | 105 |
| stability | | |
| Braking | 100 | 105 |
| performance | | |

From Table 1, it is known that the Example 1 is excellent in all of the durability performance,, the steering stability and the braking performance in comparison with the Comparative example 1.

As mentioned above, the pneumatic tire according to the present embodiment has a pair of bead portions 1, a side wall portion 2 which extends to an outer side in a tire radial directi on from each of the bead portions 1, a tread portion 3 which is connected tc an outside end in the tire radial direction of each of the side wall portions 2, a toroidal carcass layer 4 which is provided between the pair of bead portions 1, and a tread rubber 5 which, is provided in an outer side of the carcass layer 4 in the tread portion 3. The tread rubber 5 has a cap rubber 50 which is formed by a non-conductive rubber and constructs a ground contact surface E, a base rubber 51 which is provided in an inner side of the cap rubber 50 in the tire radial direction , and a conduct ive portion 52 which is formed by a conductive rubber, extends in a thickness direction RD of the tread rubber 5 and reaches a bottom surface of the tread rubber 5 from the ground contact surface E. The conductive portion 52 extends in a tire circumferential direction CD while oscillating its width in a tire width direction WD in a plan view.

As mentioned above, since the width of the conductive portion 52 in the tire width direction WD oscillates in the plan view, the force heading for the front, side acts on the cap rubber in one side in the tire width direction at a time of braking. As a result, the conductive portion 52 can sufficiently support the cap rubber 50 and can absorb the force even in the case that the force heading for the rear side (the so-called vertically displacing force) acts on the cap rubber 50 in the other side in the tire width direction. Therefore, the durability performance is improved. Further, the durability performance is improved in relation to the lateral force at a time of cornering.

According to the present embodiment, the conductive portion 52 extends in a thickness direction ED while keeping the width in the tire width direction WD constant in a tire meridian cross section.

As mentioned above, since the width of the conductive portion 52 in the tire width direction WD extends in the thickness direction RD while oscillating in the tire meridian cross section, the interfacial peeling is suppressed and the durability performance is improved on the basis of the increase of the surf ace area in the; conductive portion 52. In the case that the hardness of the conductive portion 52 is higher than that of the cap rubber 50, the steering stability on the dry road surface is improved on the basis of the even rigidity increase. On the contrary, in the case that the hardness of the conductive portion 52 is lower than that of the cap rubber 50, the steering stability and the braking performance on the wet road surface are improved on the basis of the even ground contact.

The more the conductive rubber constructing the ground contact surface increases, the more the rolling resistance and the wet steering stability are deteriorated. Accordingly, in the present embodiment, the groove 5a extending in the tire circumferential direction CD is provided, and the conductive portion 52 laps over the groove 5a partly in the plan view. As a result, a part of the conductive portion 52 constructs the ground contact surface E and the other portions construct the groove wall.

According to this structure, it is possible to reduce the conductive rubber which is exposed to the ground contact surface, in comparison with the case that the entire conductive portion is exposed as the ground contact surface. As a result, it is possible to suppress the deterioration of the rolling resistance and the wet steering stability.

According to the present embodiment, there exists a portion in which a whole of a groove wall surface and a groove bottom surface forming the groove 5a is formed by a conductive rubber in a tire meridian cross section.

According to this structure, it is possible to improve the in-plane.rigidity or the durability performance since the conductive robber supports the groove 5a in the cross section. For example, if the conductive rubber is harder than the non-conductive rubber, the in-plane rigidity is improved. If the conductive rubber is softer than the non-conductive rubber, the strain in the groove bottom, can be reduced, and the durability performance is improved.

The structures employed in each of the embodiments mentioned above can be employed in the other optional embodiments. The specific structure of each of the portions is not limited to the embodiments mentioned above, but can be variously modified within a range which does not depart from the scope of the present disclosure.

What is claimed is:

1. A pneumatic tire comprising:
a pair of bead portions;
a side wall portion which extends to an outer side in a tire radial direction from each of the bead portions;
a tread portion which is connected to an outside end in the tire radial direction of each of the side wall portions;
a toroidal carcass layer which is provided between the pair of bead portions; and
a tread rubber which is provided in an outer side of the carcass layer in the tread portion,
wherein the tread rubber has a cap rubber which is formed by a non-conductive rubber and constructs a ground contact surface, a base rubber which is provided in an inner side of the cap rubber in the tire radial direction, and a conductive portion which is formed by a conductive rubber, extends in a thickness direction of the tread rubber and reaches a bottom surface of the tread rubber from the ground contact surface, and
wherein the conductive portion extends in a tire circumferential direction while oscillating its width in a tire width direction in a plan view.

2. The pneumatic tire according to claim 1, wherein the conductive portion extends in a thickness direction while keeping the width in the tire width direction constant in a tire meridian cross section.

3. The pneumatic tire according to claim 1, wherein the conductive portion extends in a thickness direction while oscillating its width in the tire width direction in a tire meridian cross section.

4. The pneumatic tire according to claim 3, wherein a phase of the oscillation is deviated in a plan shape of the conductive portion in a tread thickness center portion in relation to a plan shape of the conductive portion in a wheel tread and a tread bottom surface, in a plan view.

5. The pneumatic tire according to claim 1, wherein the conductive portion is formed into such a shape that both end interfaces of the conductive portion in the tire width direction both oscillate in the plan view.

6. The pneumatic tire according to claim 1, wherein the conductive portion is formed into such a shape that only one end of both end interfaces of the conductive portion in the tire width direction oscillates in the plan view.

7. The pneumatic tire according to claim. lf further comprising a groove which extends in the tire circumferential direction, wherein the conductive portion partly laps over the groove in a plan view, partly constructs a ground contact surface and constructs a groove wall in the other portions.

8. The pneumatic tire according to claim 7, wherein there exists a portion in which a whole of a groove wall surface and a groove bottom surface forming the groove is formed by a conductive rubber in a tire meridian cross section.
